(19) United States
(12) Patent Application Publication
(10) Pub. No.: US 2013/0275080 A1
(43) Pub. Date: Oct. 17, 2013

(54) COMPUTING DEVICE AND METHOD FOR MEASURING SPEED OF VEHICLE

(71) Applicants: GDS SOFTWARE (SHENZHEN) CO.,LTD, Shenzhen (CN); HON HAI PRECISION INDUSTRY CO., LTD., New Taipei (TW)

(72) Inventors: CHI-CHIH WANG, New Taipei (TW); BING-YU HE, Shenzhen (CN); PO-WEI HUNG, New Taipei (TW); YAO-FENG LI, Shenzhen (CN)

(73) Assignees: HON HAI PRECISION INDUSTRY CO., LTD., New Taipei (TW); GDS SOFTWARE (SHENZHEN) CO.,LTD, Shenzhen (CN)

(21) Appl. No.: 13/729,223

(22) Filed: Dec. 28, 2012

(30) Foreign Application Priority Data
Apr. 12, 2012 (CN) 201210105242.8

(51) Int. Cl. G01P 3/68; G06F 17/00

(52) U.S. Cl. CPC G01P 3/68; G06F 17/00
USPC 702/149

(57) ABSTRACT

In a method for measuring a speed of a vehicle, the method starts a first motion sensor to sense a first position of the vehicle controls a first camera to capture a first image of the vehicle, and records a first time. A license plate number of the vehicle is identified from the first image, and a length of the vehicle is obtained from a database according to the license plate number. The method starts a second motion sensor to sense a second position of the vehicle controls a second camera to capture a second image of the vehicle, and records a second time. The method calculates a moving distance of the vehicle according to the first and the second position and the length of the vehicle, and calculates a speed of the vehicle according to the moving distance, the first time and the second time.

### BACKGROUND

1. Technical Field

Embodiments of the present disclosure relate to measuring speed of vehicles, and more particularly to a computing device and a method for measuring a speed of a vehicle.

2. Description of Related Art

Traffic management departments usually use professional speed measurement equipments, such as radar, to measure a speed of a vehicle, and to further identify whether the speed of the vehicle exceeds a speed limit. However, the professional speed measurement equipments are expensive.

### BRIEF DESCRIPTION OF THE DRAWINGS

FIG. 1 is a block diagram of one embodiment of a computing device including a vehicle speed measure system.

FIG. 2 is a block diagram of one embodiment of function modules of the vehicle speed measure system in FIG. 1.

FIG. 3 is a flowchart of one embodiment of a method for measuring a speed of a vehicle.

FIG. 4 is one exemplary embodiment illustrating the method for measuring a speed of a vehicle.

FIG. 5 is another exemplary embodiment illustrating the method for measuring a speed of a vehicle.

### DETAILED DESCRIPTION

In general, the word “module”, as used herein, refers to logic embodied in hardware or firmware, or to a collection of software instructions, written in a programming language, such as, Java, C, or assembly. One or more software instructions in the modules may be embedded in firmware, such as in an EPROM. The modules described herein may be implemented as either software and/or hardware modules and may be stored in any type of non-transitory computer-readable storage medium or other storage device. Some examples of non-transitory computer-readable storage medium may include CDs, DVDs, BLU-RAY, flash memory, and hard disk drives.

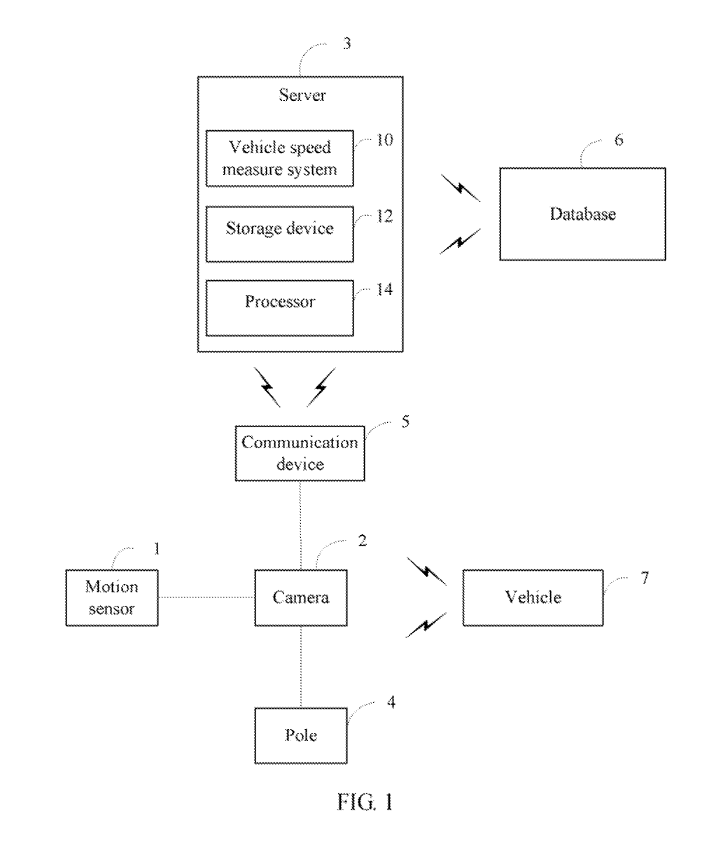

FIG. 1 is a block diagram of one embodiment of a computing device 3 including a vehicle speed measure system 10. In the embodiment, the computing device 3 communicates with at least one motion sensor 1 and at least one camera 2 through a communication device 5, and connects to a database 6 of a traffic management department which stores information of a vehicle 7, where the information of the vehicle 7 may be a length (denoted as “L”) of the vehicle and a license plate number of the vehicle 7. The motion sensor 1, the camera 2 and the communication device 5 are positioned on a pole 4 that is placed on a side of a road.

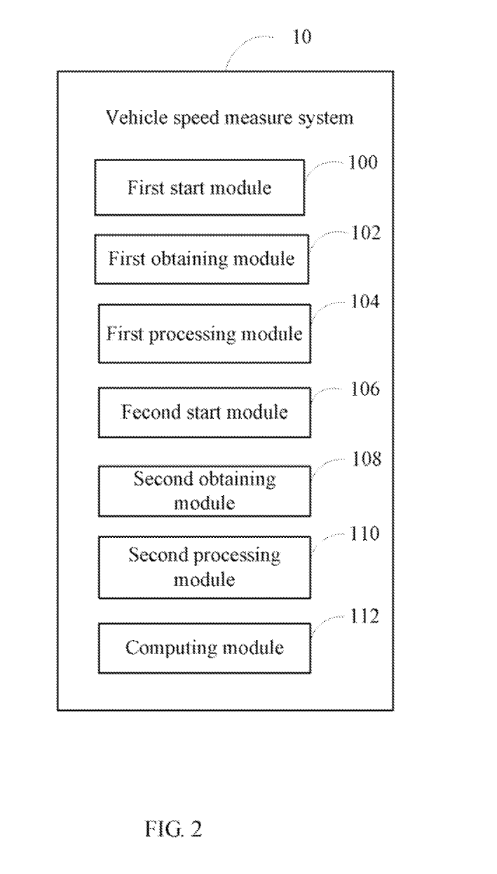

The computing device 3 further includes, but is not limited, a storage device 12, and at least one processor 14. In one embodiment, the vehicle speed measure system 10 includes a plurality of function modules (see FIG. 2 below), which include computerized codes or instructions that can be stored in the storage device 12 and executed by the at least one processor 14 to provide a method for measuring a vehicle speed of the vehicle 7. FIG. 1 is only one example of the computing device 3, other examples may include more or fewer components than those shown in the embodiment, or have a different configuration of the various components.

In the embodiment, the computing device 3 obtains images of the vehicle 7 captured by the camera 2, identifies the license plate number of the vehicle 7 from the captured images, and obtains the length L of the vehicle 7 from the database 6 of the traffic management department according the obtained license plate number.

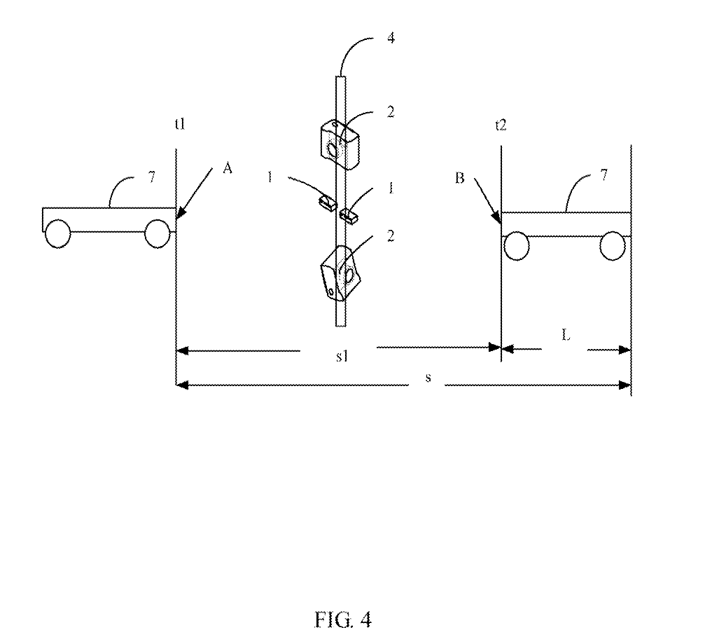

As shown in a FIG. 4, the two motion sensors 1 (e.g., a first motion sensor 1 and a second motion sensor 1) and two cameras 2 (e.g., a first camera 2 and a second camera 2) may be positioned on opposite directions of the pole 4. The first motion sensor 1 senses a first position (denoted as “A”) of the vehicle 7 and the first camera 2 captures a first image of the vehicle 7 when the vehicle 7 reaches the first position A. The second motion sensor 1 senses a second position (denoted as “B”) of the vehicle 7 and the second camera 2 captures a second image of the vehicle 7 when the vehicle 7 reaches the second position B.

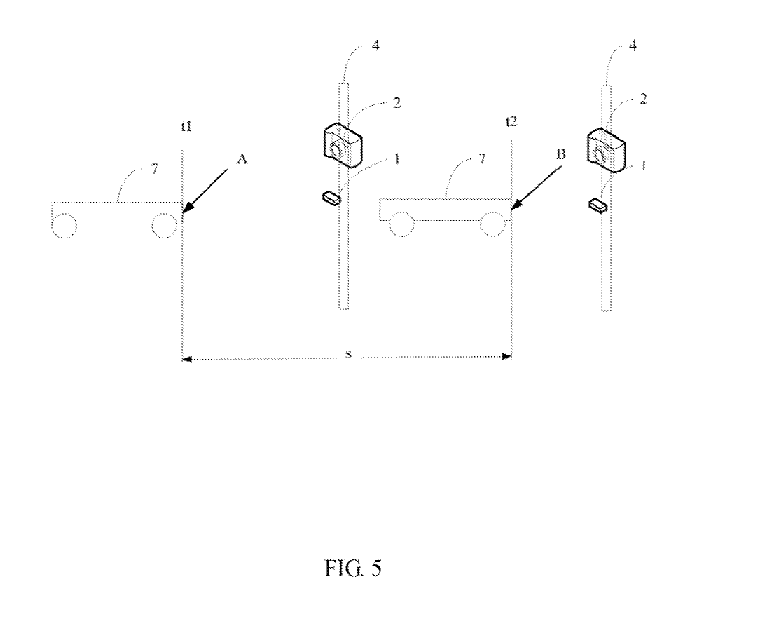

In another embodiment, the first motion sensor 1 and the first camera 2, as shown in FIG. 5, may be positioned on a same direction of two poles 4, where there is a distance interval between the two poles 4. The first motion sensor 1 senses the first position A of the vehicle 7 and the first camera 2 captures the first image of the vehicle 7 when the vehicle 7 reaches the first position A. The second motion sensor 1 senses the second position B of the vehicle 7 and the second camera 2 captures the second image of the vehicle 7 when the vehicle 7 reaches the second position B.

The communication device 5 is equipped on one pole 4, and connects the first and second couples of motion sensors 1 and cameras 2 to the computing device 3 by a wired or a wireless means.

The storage device 12 may include any type(s) of non-transitory computer-readable storage medium, such as a hard disk drive, a compact disc, a digital video disc, or a tape drive. In the embodiment, the storage device 12 stores computerized codes of the vehicle speed measure system 10.

The at least one processor 14 may include a processor unit, a microprocessor, an application-specific integrated circuit, and a field programmable gate array, for example.

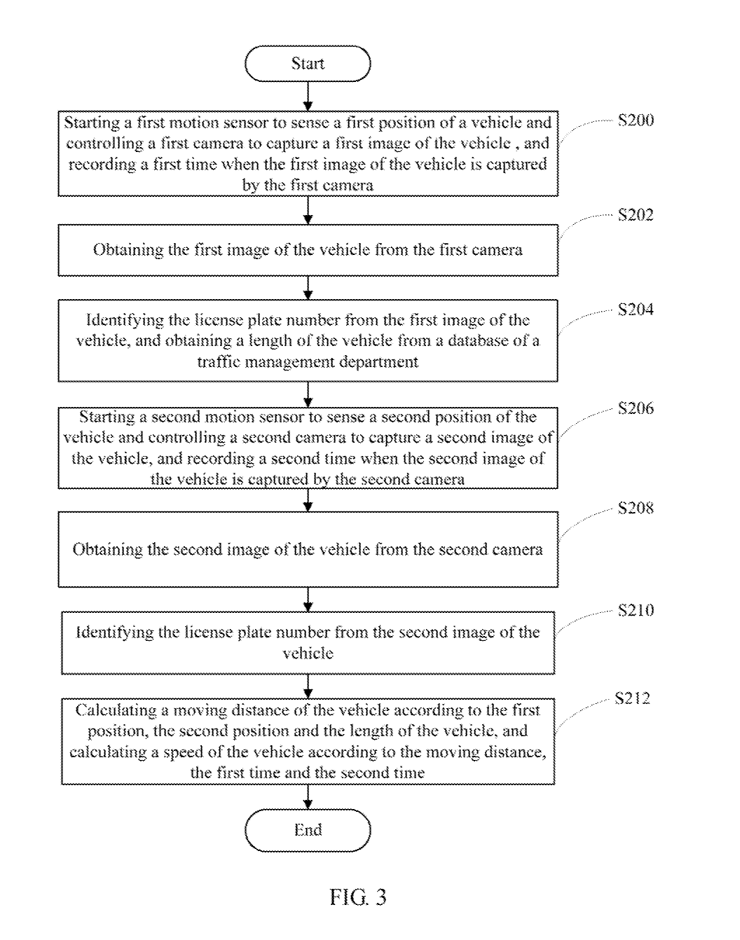

FIG. 2 is a block diagram of one embodiment of the vehicle speed measure system 10 included in the computing device 3. In one embodiment, the vehicle speed measure system 10 may include a first start module 100, a first obtaining module 102, a first processing module 104, a second start module 106, a second obtaining module 108, a second processing module 110 and a computing module 112. The modules may comprise computerized codes in the form of one or more programs that are stored in the storage device 12 and executed by the at least one processor 14 to provide functions for implementing the modules. The functions of the function modules 100-112 are illustrated in FIG. 3 and described below.

FIG. 3 illustrates a flowchart of one embodiment of a method for measuring a vehicle speed of the vehicle 7. Depending on the embodiment, additional steps may be added, others removed, and the ordering of the steps may be changed.

In step S200, the first start module 100 starts the first motion sensor 1 to sense the first position A of the vehicle 7 and controls the first camera 2 to capture the first image of the vehicle 7 when the vehicle 7 reaches the first position A, and records a first time (denoted as “t1”) when the first image of the vehicle 7 is captured by the first camera 2, wherein the first image includes a license plate number of the vehicle 7.

In step S202, the first obtaining module 102 obtains the first image of the vehicle 7 from the first camera 2 through the communication device 5.

In step S204, the first processing module 104 identifies the license plate number from the first image of the vehicle 7, and obtains the length L of the vehicle 7 from the database 6 of the traffic management department according to the obtained license plate number.

In step S206, the second start module 106 starts the second motion sensor 1 to sense the second position B of the vehicle 7 and controls the second camera 2 to capture the second image of the vehicle 7 when the vehicle 7 reaches the second position B, and records a second time (denoted as “t2”) when the second image of the vehicle 7 is captured by the second camera 2, wherein the second image also includes the license plate number of the vehicle 7.

In step S208, the second obtaining module 108 obtains the second image of the vehicle 7 from the second camera 2 through the communication device 5.

In step S210, the second processing module 110 identifies the license plate number from the second image of the vehicle 7.

In step S212, the computing module 112 calculates a moving distance (denoted as “S”) of the vehicle 7 according to the first position A, the second position B and the length L of the vehicle 7, and calculates a speed (denoted as “V”) of the vehicle 7 according to the moving distance S, the first time t1 and the second time t2: V=S/(t2−t1).

In the embodiment, as shown in the FIG. 4, if the two motion sensors 1 and the two cameras 2 are positioned on opposite directions of one pole 4, the first image includes the license plate number in the front of the vehicle 7 and the second image includes the license plate number in the back of the vehicle 7, the moving distance S of the vehicle 7 is calculated as a sum of the length L of the vehicle 7 and an interval distance (denoted as “S1”) between the first position A and the second position B. That is, the speed of the vehicle 7 may be calculated as:

V=S/(t2−t1)=(S1+L)/(t2−t1).

In another embodiment, as shown in the FIG. 5, if the two motion sensors 1 and the two cameras 2 are positioned on a same direction of the two poles 4, the first image and the second image both include the license plate number in the front of the vehicle 7, and the speed of the vehicle 7 may be calculated as: V=S/(t2−t1)=S1/(t2−t1), wherein S1 is the interval distance between the first position A and the second position B.

Although certain embodiments of the present disclosure have been specifically described, the present disclosure is not to be construed as being limited thereto. Various changes or modifications may be made to the present disclosure without departing from the scope and spirit of the present disclosure.

What is claimed is:

1. A computing device, comprising:
a storage device;
at least one processor; and
one or more modules that are stored in the storage device and executed by the at least one processor, the one or more modules comprising:
a first start module that starts a first motion sensor to sense a first position of a vehicle and controls a first camera to capture a first image of the vehicle when the vehicle reaches a first position, and records a first time when the first image of the vehicle is captured by the first camera;
a first obtaining module that obtains the first image of the vehicle from the first camera;
a first processing module that identifies a license plate number from the first image of the vehicle, and obtains a length of the vehicle from a database of a traffic management department according to the license plate number of the vehicle;
a second start module that starts a second motion sensor to sense a second position of the vehicle and controls a second camera to capture a second image of the vehicle when the vehicle reaches the second position, and records a second time when the second image of the vehicle is captured by the second camera; and
a computing module that calculates a moving distance of the vehicle according to the first position, the second position and the length of the vehicle, and calculates a speed of the vehicle according to the moving distance, the first time and the second time.

2. The computing device according to claim 1, wherein the two motion sensors and the two cameras are positioned on opposite directions of one pole, and the first image includes the license plate number in the front of the vehicle and the second image includes the license plate number in the back of the vehicle.

3. The computing device according to claim 2, wherein the moving distance of the vehicle is calculated as a sum of the length of the vehicle and an interval distance between the first position and the second position.

4. The computing device according to claim 1, wherein the two motion sensors and the two cameras are positioned on a same direction of two poles, and wherein the first image and the second image both include the license plate number in the front of the vehicle.

5. The computing device according to claim 4, wherein the moving distance of the vehicle is equal to the interval distance between the first position and the second position.

6. The computing device according to claim 1, wherein the one or more modules further comprises:
a second obtaining module that obtains the second image of the vehicle from the second camera; and
a second processing module that identifies the license plate number from the second image of the vehicle.

7. A method for measuring a speed of a vehicle, the method comprising:
starting a first motion sensor to sense a first position of a vehicle and controlling a first camera to capture a first image of the vehicle when the vehicle reaches a first position, and recording a first time when the first image of the vehicle is captured by the first camera;
obtaining the first image of the vehicle from the first camera;
identifying a license plate number from the first image of the vehicle, and obtaining a length of the vehicle from a database of a traffic management department according to the license plate number of the vehicle;
starting a second motion sensor to sense a second position of the vehicle and controlling a second camera to capture a second image of the vehicle when the vehicle reaches the second position, and recording a second time when the second image of the vehicle is captured by the second camera;
calculating a moving distance of the vehicle according to the first position, the second position and the length of the vehicle; and
calculating a speed of the vehicle according to the moving distance, the first time and the second time.

8. The method according to claim 7, wherein the two motion sensors and the two cameras are positioned on opposite directions of one pole, and the first image includes the license plate number in the front of the vehicle and the second image includes the license plate number in the back of the vehicle.

9. The method according to claim 8, wherein the moving distance of the vehicle is calculated as a sum of the length of the vehicle and an interval distance between the first position and the second position.

10. The method according to claim 7, wherein the two motion sensors and the two cameras are positioned on a same directions of two poles, and wherein the first image and the second image both include the license plate number in the front of the vehicle.

11. The method according to claim 10, wherein the moving distance of the vehicle is equal to the interval distance between the first position and the second position.

12. The method according to claim 7, further comprising:
obtaining the second image of the vehicle from the second camera; and
identifying the license plate number from the second image of the vehicle.

13. A non-transitory computer-readable storage medium having stored thereon instructions when executed by a processor of a computing device, causes the processor to perform a method for measuring a speed of a vehicle, the method comprising:
starting a first motion sensor to sense a first position of a vehicle and controlling a first camera to capture a first image of the vehicle when the vehicle reaches a first position, and recording a first time when the first image of the vehicle is captured by the first camera;
obtaining the first image of the vehicle from the first camera;
identifying a license plate number from the first image of the vehicle, and obtaining a length of the vehicle from a database of a traffic management department according to the license plate number of the vehicle;
starting a second motion sensor to sense a second position of the vehicle and controlling a second camera to capture a second image of the vehicle when the vehicle reaches the second position, and recording a second time when the second image of the vehicle is captured by the second camera;
calculating a moving distance of the vehicle according to the first position, the second position and the length of the vehicle; and
calculating a speed of the vehicle according to the moving distance, the first time and the second time.

14. The storage medium according to claim 13, wherein the two motion sensors and the two cameras are positioned on opposite directions of one pole, and the first image includes the license plate number in the front of the vehicle and the second image includes the license plate number in the back of the vehicle.

15. The storage medium according to claim 14, wherein the moving distance of the vehicle is calculated as a sum of the length of the vehicle and an interval distance between the first position and the second position.

16. The storage medium according to claim 13, wherein the two motion sensors and the two cameras are positioned on a same direction of two poles, wherein the first image and the second image both include the license plate number in the front of the vehicle.

17. The storage medium according to claim 16, wherein the moving distance of the vehicle is equal to the interval distance between the first position and the second position.

18. The storage medium according to claim 13, wherein the method further comprises:
obtaining the second image of the vehicle from the second camera; and
identifying the license plate number from the second image of the vehicle.
